(19) United States
(12) Patent Application Publication
(10) Pub. No.: US 2003/0036345 A1
(43) Pub. Date: Feb. 20, 2003

(54) Sportsman's game meat hanger

(76) Inventor: Eddie Conner, Klamath River, CA (US)

Correspondence Address: CHARLES C. LOGAN II, 8282 UNIVERSITY AVENUE, LA MESA, CA, 91941, US

(21) Appl. No.: 09/928,959

(22) Filed: Aug. 14, 2001

(51) Int. Cl. A22B 1/00; A22B 7/00; A22C 18/00

(52) U.S. Cl. 452/187

(57) ABSTRACT

A sportsman's game meat hanger having an elongated shank portion having a top end and a bottom end. An eye portion is formed adjacent the top end for securing one end of a rope thereto. A hook portion is formed on the bottom end of the shank portion and it is inserted into a portion of a game animal that has been shot. A pair of tie-off rods are secured to the rear side of the shank portion. In use, the free end of the rope is thrown over the limb of a tree and the game animal is hoisted to a desired height. The rope is then cleated on the rope tie-off rods and then secured with a half-hitch or other comparable simple knot. With the rope cleated the knot remains free from tension, allowing the knot to be easily untied. If a game bag is used then the free end of the rope can be tied around the top of the bag; enclosing and protecting the meat.

### BACKGROUND OF THE INVENTION

The invention relates to a meat hanger and more specifically one to be used in the woods or fields by a hunter.

One of the most integral parts of a big game hunting trip (such as elk, bear or deer) is that after an animal is shot it must be hung in the air for cleaning, curing and protection from other wildlife. Hanging the meat also facilitates bagging or covering the meat which would prevent any damage from flies or birds. If the animal is small enough (like a small deer) it can be hoisted as a whole piece. However, if the animal is large it will have to be hung in multiple pieces.

Most of the devices used for helping the hunter hoist the animal for cleaning, curing and protecting the meat have proven unsuccessful.

The Keller U.S. Pat. No. 2,931,629 is directed to a system for dragging a deer and also hoisting it off the ground. It has a pulley that may be used in various ways, for example, for suspending a deer from a tree limb, or alternatively, as a means for dragging a deer back to camp.

The Reiner U.S. design Pat. No. 312,388 is directed to a big game hanger. This patent discloses a hook attached to each of the opposite ends of a horizontal bar. A pair of braces extend upwardly from the respective ends to a metal bracket having a hole in it, presumably for receiving a rope or chain or hook.

In the related area of hanging or suspending a large animal, other structures have been designed. The Reich U.S. Pat. No. 3,043,547 is directed to a hanger for meat products. Also the Gray U.S. Pat. No. 3,210,802 is directed to a method of severing a section of meat from a large suspended body thereof.

It is an object of the invention to provide a novel sportsman's game meat hanger that is lightweight and compact so that it can be easily carried by a hunter.

It is also another object of the invention to provide a novel sportsman's game meat hanger to which a rope can be attached which allows a single person to raise large, heavy or bulky portions of game to a desired height and at the same time secure the elevated game using only one hand without having to tie a conventional knot in the line or rope; at which time both hands become free so a single half hitch knot can be tied for additional security. This knot would have no strain on it so removal will be easy and done with both hands, with original security not being compromised.

It is another object of the invention to provide a novel sportsman's game meat hanger that eliminates a prior art problem when the knot on the rope holding the game animal up becomes too tight to untie and thereby forcing the hunter to cut the rope to remove the animal.

It is an additional object of the invention to provide a novel sportsman's game meat hanger that could also be used by a do-it-yourself home butcher.

It is a further object of the invention to provide a novel sportsman's game meat hanger that is economical to manufacture and market.

### SUMMARY OF THE INVENTION

The novel sportsman's game meat hanger has an elongated shank portion having an eye portion formed on its top end to which a rope approximately 8-12 feet long would be attached. The bottom end of the shank portion has a hook portion that would be inserted into a proper location on a game animal so that it could be hoisted to a desired height for the purpose of cleaning, curing and keeping it secure from other animals. The rear side of the shank portion has a pair of rope tie-off rods extending away from the shank portion at acute angles.

In its preferred embodiment, an elongated rod made of stainless steel would have its bottom end bent to form the hook portion and its top end bent to form the eye portion. The rope tie-off rods would be a single member bent at the desired angles and secured to the rear side of the shank portion by welding.

The manner in which the sportsman's game meat hanger would be used will now be described. First, the hook portion would be inserted into a portion of the meat. Next, the rope that is attached to the meat hanger would be thrown over the top of a tree limb or elevated pole; allowing the meat to be hoisted to a desired height for the purposes of cleaning, curing and protecting the meat from other animals. When the animal is at the desired height, the hunter would wrap an intermediate portion of the rope twice around the rope tie-off rods of the hanger. This would allow the weight of the animal to rest on the wraps around the tie-off rods. With the wraps bearing all of the weight the final knot could be a simple one (like a half-hitch) with the sole purpose of securing the rope which is wrapped around the tie-off rods. Since the knot itself would not be bearing any of the weight it would be easy to tie and untie. In the past when the knot was too tight (because of bearing the weight of the animal) it was necessary for the hunter to cut the rope to lower the animal because the knot could not be untied.

### DESCRIPTION OF THE DRAWINGS

FIG. 1A is a rear perspective view illustrating a game animal hanging from a tree limb by two novel sportsman's meat hangers;

FIG. 1B is a front perspective view illustrating two portions of game meat hanging from a tree limb by two novel sportsman's game meat hangers;

FIG. 2 is a front elevation view of the novel sportsman's game meat hanger;

FIG. 3 is a left side elevation view of the novel sportsman's game meat hanger; and

FIG. 4 is a left side elevation view of the novel sportsman's game meat hanger showing the manner in which the rope is secured to both the eye portion and also the rope tie-off rods during use.

### DESCRIPTION OF THE PREFERRED EMBODIMENT

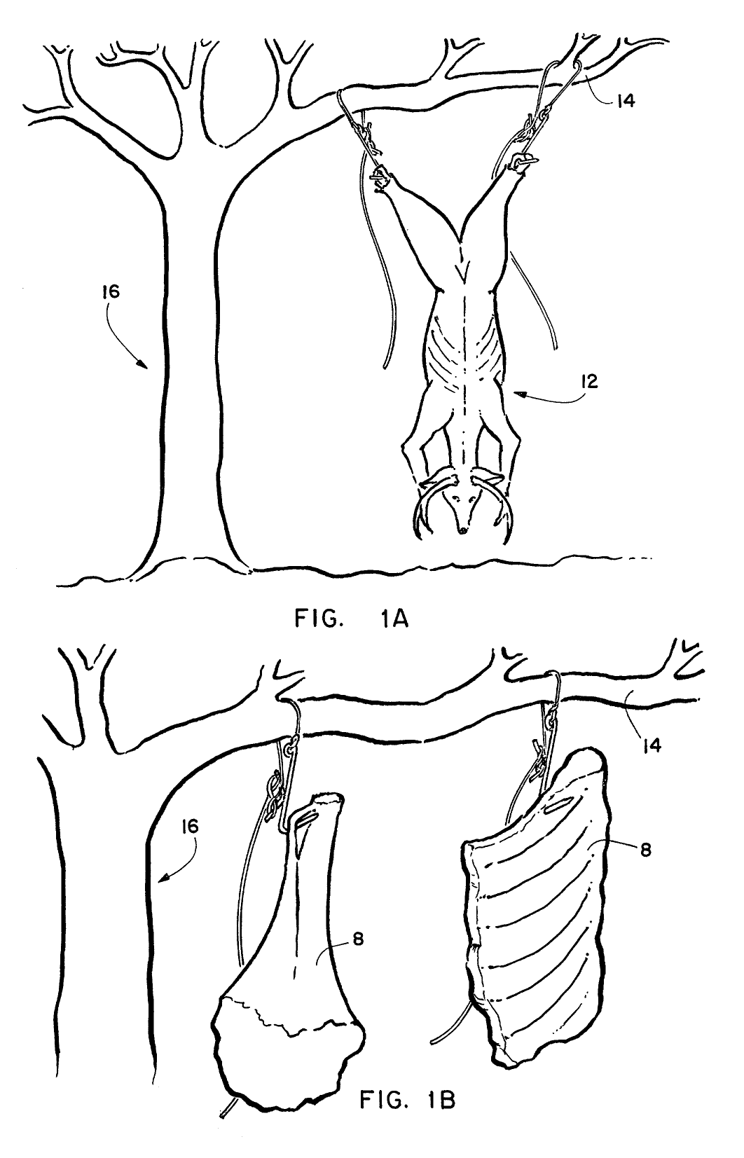

The novel sportsman's game meat hanger is best described by referring to FIGS. 1-4 of the drawings. The game meat hanger is generally designated numeral 10. In FIG. 1A a game animal such as deer 12 is shown hanging from a limb 14 of a tree 16. In FIG. 1B two portions of a game animal 8 are shown hanging from a limb 14 of a tree 16.

Game meat hanger 10 has an elongated shank portion 20 having a longitudinal extending X-axis. Shank portion 20 has a top end 22 having an integrally formed eye portion 24. Bottom end 26 has been bent to form a hook portion 28. Shank portion 20 has a front side 30 and a rear side 32. Game meat hanger 10 has a height H1 in the range of 8-18 inches. Hook portion 28 has length Li in the range of 2-5 inches. Rope tie-off rods 40 and 42 form a cleat 44 that is welded to rear side 32 of shank portion 20. Rope tie-off rod 40 has a longitudinally extending Y-axis that makes an acute angle A with shank portion 20. Rope tie-off rod 42 has a Z-axis that makes an acute angle B with shank portion 20. In the preferred embodiment, cleat 44 would also be made of stainless steel. Rope tie-off rods 40 and 42 have a length L2 in the range of 1-3 inches.

In FIG. 4, a rope 50 is illustrated having its first end 52 threaded through eye portion 24 and tied into a knot 54. Rope 50 has a first intermediate portion 56, a second intermediate portion 58 and a third intermediate portion 60. Second intermediate portion 58 is wrapped twice around the rope tie-off rods 40 and 42 and the third intermediate portion 60 is then tied in a knot 62 around the second intermediate portion 58 of rope 50, the cleat 44 and the shank 20. Since knot 62 is not under the tension of the weight of the animal, this knot can easily be untied at any time. The second end of rope 64 is free to secure a game bag or other covering over the meat if so desired.

What is claimed is:

1. A sportsman's game meat hanger comprising:
an elongated shank portion having a top end, a bottom end, a front side and a rear side;
means adjacent said top end of said shank portion for securing one end of a rope thereto;
a hook portion formed on said bottom end of said shank portion and said hook portion extends forwardly from said front side of said shank portion; and
at least one rope tie-off rod attached to said shank portion intermediate said top end and said bottom end of said shank portion.

2. A sportsman's game meat hanger as recited in claim 1 wherein said means adjacent said top end of said shank portion is an eye portion.

3. A sportsman's game meat hanger as recited in claim 2 wherein said eye portion is integrally formed from the same piece of material as said shank portion and said hook portion.

4. A sportsman's game meat hanger as recited in claim 3 wherein said shank portion and said tie-off rod are made of stainless steel.

5. A sportsman's game meat hanger as recited in claim 1 wherein there are at least two tie-off rods attached to said shank portion.

6. A sportsman's game meat hanger as recited in claim 5 wherein said two tie-off rods are attached to said rear side of said shank portion.

7. A sportsman's game meat hanger as recited in claim 6 wherein said two tie-off rods are integrally formed from a single rod member that has been welded to said shank portion.

8. A sportsman's game meat hanger as recited in claim 1 wherein said shank portion has a longitudinally extending X-axis.

9. A sportsman's game meat hanger as recited in claim 8 wherein said shank portion has a height H1 in the range of 8-18 inches.

10. A sportsman's game meat hanger as recited in claim 9 wherein said meat hanger has a weight in the range of 1-6 pounds.

11. A sportsman's game meat hanger as recited in claim 1 in combination with a length of rope having a first end, a first, second and third intermediate portion, and a second end; said first end being secured to said means adjacent said top end of said shank portion; said second intermediate portion being secured to said rope tie-off rod; said third intermediate portion tied around said second intermediate portion, said shank and said tie-off rod; said second end of said rope is free to secure game bag or other meat covering if desired.

12. A method of using said sportsman's game meat hanger as recited in claim 1 comprising the following steps:
a) securing a first end of a rope to said means adjacent said top end of said shank portion;
b) inserting said hook portion of said meat hanger into a portion of a game animal;
c) throwing a second end of said rope over the limb of a tree or other elevated pole and hoisting said portion of game animal off the ground to a desired height where the portion can be cleaned, cured and protected from other wild life;
d) wrapping the second intermediate portion of said rope around said rope tie-off rod to keep said animal at said desired height;
e) tying a knot with said third intermediate portion of said rope around said second intermediate portion, said shank and said tie-off rod; leaving said knot without tension to be easily untied and said second end of said rope free to secure game bag or other meat covering if desired.
